(19) United States
(12) Patent Application Publication
(10) Pub. No.: US 2025/0308292 A1
(43) Pub. Date: Oct. 2, 2025

(54) PROCESSOR DERIVED PREVENTATIVE MAINTENANCE SUGGESTION CORRESPONDING TO A BICYCLE COMPONENT

(71) Applicant: Fox Factory, Inc., Duluth, GA (US)

(72) Inventors: Thomas Pollock, Fletcher, NC (US); Christopher Otterness, Asheville, NC (US); Joshua Coaplen, Asheville, NC (US); Everet Owen Ericksen, Woodland, CA (US); Evan Peterson, Santa Cruz, CA (US)

(73) Assignee: Fox Factory, Inc., Duluth, GA (US)

(21) Appl. No.: 19/097,157

(22) Filed: Apr. 1, 2025

Related U.S. Application Data
(60) Provisional application No. 63/573,430, filed on Apr. 2, 2024.

(51) Int. Cl. G07C 5/00; B62J 1/08; B62J 50/22

(52) U.S. Cl. CPC G07C 5/006; G07C 5/008; B62J 1/08; B62J 2001/085; B62J 50/22

(57) ABSTRACT

A system for generating a preventative maintenance suggestion corresponding to a bicycle component. A plurality of sensors determines a value for an operational aspect of the bicycle component. A processor receives the value for the operational aspect of the bicycle component from the sensor and corrects the value to obtain a corrected value for the operational aspect of the bicycle component. The operational aspect of the bicycle component is not solely based upon a time-based measurement. A preventative maintenance suggestion module provides a preventative maintenance suggestion to a user of the bicycle component based upon the corrected value for the operational aspect of the bicycle component.

### CROSS-REFERENCE TO RELATED APPLICATIONS

This Application claims benefit of co-pending U.S. Provisional Patent Application Ser. No. 63/573,430 (Attorney Docket No. FOX-0228US.PRO), filed Apr. 2, 2024, entitled “MICROPROCESSOR DERIVED SERVICE INTERVALS FOR PREVENTATIVE MAINTENANCE OF BICYCLE PRODUCTS” by Thomas Pollock et al. which is incorporated herein in its entirety by reference thereto.

### BACKGROUND OF THE INVENTION

### Field of the Invention

The invention relates generally to bicycle components and, more specifically, to service intervals for bicycle components.

### Description of the Related Art

Preventative maintenance is often necessary to ensure proper performance of various bicycle components. Additionally, it is often critical that such preventative maintenance is performed when appropriate. For example, waiting too long to perform preventative maintenance can result in degraded performance of a bicycle component or even damage to the bicycle component. On the other hand, performing preventative maintenance on a bicycle component before it is actually needed may introduce unnecessary cost and may also reduce a rider's opportunity to use and enjoy their bicycle.

### BRIEF DESCRIPTION OF THE DRAWINGS

Aspects of the present invention are illustrated by way of example, and not by way of limitation, in the accompanying drawings, wherein:

FIG. 1 is a perspective view of a bicycle having a bicycle component coupled thereto, wherein the bicycle component is a dropper seatpost, in accordance with an embodiment of the present invention.

FIG. 2 is a flow chart of operations for generating a preventative maintenance suggestion corresponding to a dropper seatpost, in accordance with an embodiment of the present invention.

The drawings referred to in this description should be understood as not being drawn to scale except if specifically noted.

### DETAILED DESCRIPTION

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

Preventative maintenance schedules, also referred to herein as service intervals, for bicycle components are often time-based. Such time-based preventative maintenance schedules are commonly expressed in terms of a bicycle's “ride time” or the number of hours of “use time” for a bicycle. Ride time (or use time) is a poor metric for determining a bicycle component's preventative maintenance schedule because the amount of usage of a given bicycle component can vary significantly between rides, even when such rides are of the same duration.

As one example, assume that the bicycle component is a dropper seatpost. When a bicycle with a dropper seatpost is used during a bicycle ride in very mountainous terrain, the dropper seatpost might only be actuated one time at the bottom of a long climb, and then be actuated a second time at the top of the long climb before descending. Hence, even if the duration of the aforementioned ride through very mountainous terrain is several hours, the dropper seatpost is only actuated two times. As a result, in the present example, the bicycle component (i.e., the dropper seatpost) has a very low ratio of “actuations” to “hours of bicycle usage”.

Conversely, as another example, if the same bicycle with the same dropper seatpost is used during a ride through rolling terrain, the dropper seatpost may be actuated tens or hundreds of times during the ride. Assuming that the duration of the ride through rolling terrain is similar to the duration of the aforementioned ride through very mountainous terrain, the dropper seatpost will now have a much higher ratio of “actuations” to “hours of bicycle usage”. Thus, such differences in the ratio of “actuations” to “hours of bicycle usage” clearly indicate that a conventional time-based preventative maintenance schedule (or service interval) is not suitable for, for example, a dropper seatpost, as wear of the dropper seatpost is due to movement (actuations) not merely stationary time or hours of bicycle usage. More specifically, considering the above two examples of ride types, it is likely that a conventional time-based preventative maintenance schedule (or service interval) would be too frequent, or too short, for a dropper seatpost which is used primarily for very mountainous terrain rides. Also, it is likely that a conventional time-based preventative maintenance schedule (or service interval) would not be frequent enough, or too long, for a dropper seatpost which is used primarily for rolling terrain rides.

As will be described in detail below, embodiments of the present invention provide a preventative maintenance suggestion corresponding to a bicycle component, wherein the preventative maintenance suggestion is not solely time-based, is not based solely upon bicycle ride time, and is not based solely upon hours of bicycle usage or hours of usage of the bicycle component. Moreover, in various embodiments, the preventative maintenance suggestion will include, for example, one or more of: a preventative maintenance schedule for a bicycle component; a suggested service interval for a bicycle component; and various other types of preventative maintenance suggestions for a bicycle component.

For purposes of brevity and clarity, the following discussion will specifically refer to a dropper seatpost bicycle component to illustrate the various embodiments of the present invention. It should be understood, however, that various embodiments of the present invention are also well suited to use with bicycle components other than a dropper seatpost.

With bicycle components (e.g., certain dropper seatposts) becoming more commonplace, embodiments of the present invention provide a solution generating a preventative maintenance suggestion corresponding to a bicycle component. The preventative maintenance suggestion provided by embodiments of the present invention is significantly more accurate than, and is significantly improved when compared to, conventional time-based approaches. More specifically, the preventative maintenance suggestion provided by various embodiments of the present invention is derived from actual dropper seatpost usage metrics which are determined using one or more sensors. Moreover, in various embodiments, the present invention provides such a preventative maintenance suggestion to a dropper seatpost user via, for example, the user's mobile device or other mechanism including an audio-based mechanism, a visual-based mechanism, a tactile-based mechanism or any combination thereof.

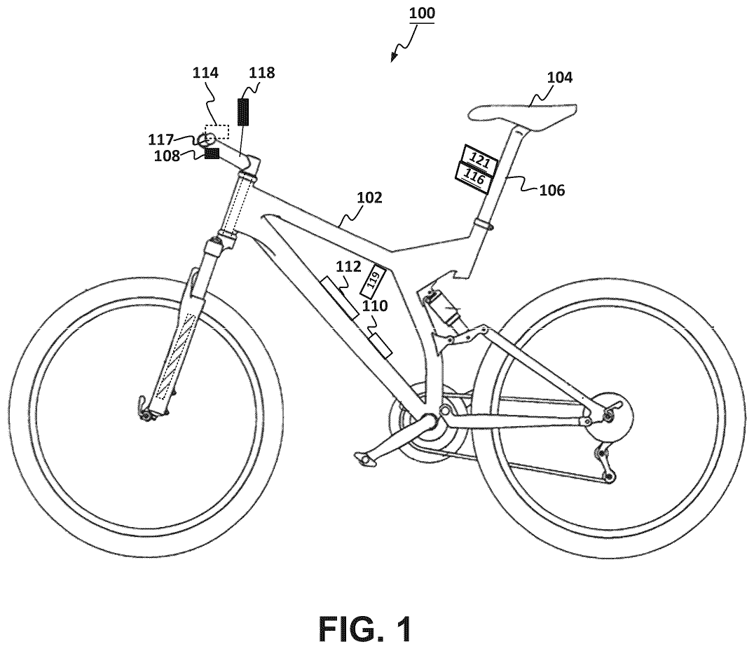

Referring now to FIG. 1, a perspective view of a bicycle 100 having a plurality of bicycle components is shown in accordance with various embodiments of the present invention. A seat 104 is connected to the bicycle frame 102 via a dropper seatpost 106 in order to support a user/rider of bicycle 100. In one embodiment, dropper seatpost 106 is used to adjustably retain and/or adjust the height of saddle 104 with respect to main frame 102, without modifying a yaw or a pitch position of saddle 104 with respect to main frame 102. In one embodiment, dropper seatpost 106 is used to adjustably retain and/or adjust the height of saddle 104 with respect to main frame 102, and may also modify one or both of the yaw and pitch positions of saddle 104 with respect to main frame 102. Regarding a dropper seatpost, details regarding the structure and operation of a dropper seatpost are found in U.S. Pat. Nos.: 9,422,018; 9,963,181; 10,427,741; 10,472,013; 11,091,215; 11,021,204; 11,897,571; 11,904,966; and 12,269,548, each of which is assigned to the assignee of the present application, and each of which is incorporated herein by reference in its entirety.

Although a single bicycle type is depicted in FIG. 1, the bicycle component (e.g., dropper seatpost 104) could be used on another vehicle such as, but not limited to a road bike, a mountain bike, a gravel bike, an electric bike (e-bike), a hybrid bike, and the like. However, in the following discussion, and for purposes of clarity, bicycle 100 is utilized as the example vehicle and dropper seatpost 106 is used as the example bicycle component.

In one embodiment, bicycle 100 also has various other features coupled therewith, including a switch 108 for manually actuating dropper seatpost 106, a processor 110, a power source user 112, an optional user interface 114 and a plurality of sensors 116, 117 and 119. In one embodiment, sensor 117 detects the number of depressions of switch 108, and sensor 119 detects the number of times an actuation request signal is sent to dropper seatpost 106. In various embodiments, sensor 116 detects the actual number of actuations of dropper seatpost 106. In embodiments of the present invention, the combined input from sensors 116, 117 and 119 is used to determine a value for the apparent actuations of dropper seatpost 106. Various embodiments of the present invention are well suited to having a greater or lesser number of sensors coupled with bicycle 100 and processor 110. Additionally, various embodiments of the present invention are well suited to having sensors coupled with bicycle 100 at locations other than the locations depicted in FIG. 1.

In various embodiments, sensor 116 is integrated within processor 110. In other embodiments sensor 116 is coupled with bicycle 100 at a location which is physically separate from processor 110. In another embodiment, sensor 116 is disposed near/proximate to dropper seatpost 106. Also, in various embodiments, sensor 116 is integrated with a motive unit for dropper seatpost 106.

With reference still to FIG. 1, in various embodiments, processor 110 may be considered a controller. In various other embodiments, processor 110 is integrated within a controller. In other embodiments processor 110 is coupled with bicycle 100 at a location which is physically separate from a controller. In another embodiment, processor 110 is disposed near/proximate to dropper seatpost 106. Also, in various embodiments, processor 110 is integrated with a motive unit for dropper seatpost 106.

Information regarding sensors, such as sensors 116, 117 and 119, wired or wireless control of a sensor, wired or wireless communication with a sensor, processors, such as processor 110, wired or wireless control of a processor (also referred to herein as controller), wired or wireless communication with a processor, bicycle components, adjustments to bicycle components, modifications to bicycle components, communication with a bicycle component's user via a mobile device (or other device), bicycle component replacement aspects (including manually, semi-actively, and/or actively controlled bicycle components), wired or wireless control of bicycle components, and wired or wireless communication with bicycle components is provided in U.S. Pat. Nos.: 7,484,603; 8,838,335; 8,1185,653; 9,303,712; 9,353,818; 9,682,604; 9,797,467; 10,036,443; 10,060,499; 10,415,662; 10,443,671; 10,737,546; 11,713,093 and 12,151,771, each of which is assigned to the assignee of the present application, and each of which is incorporated herein by reference in its entirety.

FIG. 1 also depicts an optional feature, mobile device 118, which, in various embodiments, may be removably coupled with bicycle 100. In one embodiment, mobile device 118 is mounted to handlebar of bicycle 100. Although mobile device 118 is shown mounted to a handlebar, it should be appreciated that mobile device 118 could be located in a rider's backpack, pocket, or the like. Hence, as will be discussed below in detail, FIG. 1 depicts the various features of a system embodiment of the present invention for generating a preventative maintenance suggestion corresponding to a bicycle component.

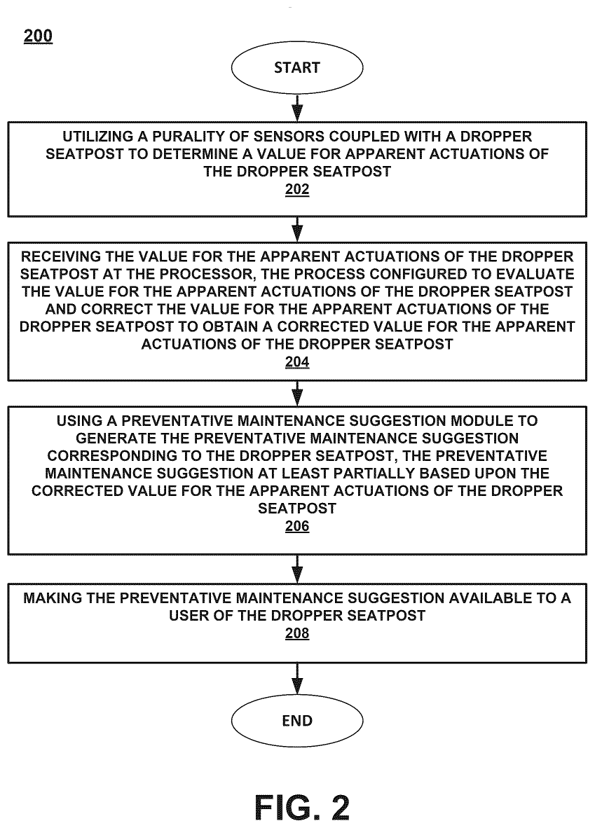

Referring now to FIG. 2 and, more specifically, 202 of flow chart 200, in various embodiments of the present invention, sensors 116, 117 and 119 are configured to determine a value for an operational aspect of a bicycle component. In one embodiment, the operational aspect determined by sensors 116, 117 and 119 is the number of apparent actuation events for said dropper seatpost 106. More specifically, in one embodiment, sensors 116, 117 and 119 each function as a counter and count the number of times dropper seatpost 106 has apparently been actuated. Such apparent actuations are based upon, for example, the number of times that switch 108 has been depressed by a user of bicycle 100, the number of times an actuation signal has been sent to dropper seatpost 106, and the number of actuations of dropper seatpost 106.

In another embodiment, sensor 116 measures the number of times dropper seatpost 106 has moved. In yet another embodiment, sensor 116 sensor is coupled with a motive mechanism of dropper seatpost 106, and, in order to determine the number of times that dropper seatpost 106 has apparently been actuated, sensor 116 measures the number of times that the motive mechanism has been activated. In various other embodiments, sensor 116 measures the energy usage by a motive mechanism of dropper seatpost 106, in order to measure the number of times dropper seatpost has apparently been actuated. It will be understood that, in various embodiments of the present invention, sensor 116 can be configured, and/or located, to monitor any of a plurality of instances or events which result in a successful actuation of dropper seatpost 106. Additionally, in various embodiments of the present application, an “actuation” may be defined by “duty cycles” (dropper seatpost 106 is moved down, or dropper seatpost 106 is moved down) or simply the number of distinct state changes of some portion of the controller or motive force of dropper seatpost 106. As such, in various embodiments of the present invention, processor 110 will ultimately determine a value for an operational aspect of a bicycle component. More specifically, in the present embodiment, processor 110 will ultimately determine a value for successful actuations of dropper seatpost 106.

Additionally, in various embodiments of the present invention one or more of sensors 116, 117 and 119 could be located in other locations and/or configured to sense and/or measure various other features such as fluid properties, strain, acceleration, current, voltage, resistance, noise, positions of one or more components of bicycle 100, gyroscopic data (e.g., angle-change), microphones and the like to measure operational aspects (e.g., apparent actuation events for dropper seatpost 106) for any of various bicycle components. It should be further noted that, in embodiments of the present invention, the operational aspect of the bicycle component (e.g., dropper seatpost 106) is not solely based upon a time-based measurement for a bicycle (e.g., bicycle 100) with which the bicycle component is coupled and/or utilized. Additionally, in various embodiments of the present invention sensors 116, 117 and 119 will measure apparent actuations of dropper seatpost 106 when the apparent actuation events for dropper seatpost 106 are generated manually by a user of dropper seatpost 106 and/or when the apparent actuation events for dropper seatpost 106 are automatically generated based upon a particular condition, a specific location, or the like.

Referring again to FIG. 2 and, more specifically, to 204 of flow chart 200, in various embodiments of the present invention, processor 110 is configured to be communicatively coupled with sensors 116, 117 and 119. That is, in various embodiments of the present invention, processor 110 is configured to receive the aforementioned values for the apparent actuation events for dropper seatpost 106 from sensors 116, 117 and 119. In various embodiments of the present invention, processor 110 is further configured to evaluate the value for the operational aspect of a bicycle component and then correct the value for the operational aspect of the bicycle component to obtain a corrected value for the operational aspect of the bicycle component. In various embodiments of the present invention, processor 110 receives the values of the apparent actuation events for dropper seatpost 106 from each of sensors 116, 117 and 119. Processor 110 then obtains a corrected value for the apparent actuation events for dropper seatpost 106 by identifying unsuccessful actuations of dropper seatpost 106, wherein the unsuccessful actuations of dropper seatpost 106 were previously included in the value for the apparent actuation events for dropper seatpost 106 reported to processor 110 by sensors 116, 117 and 119. It should be noted that in some instances, the value for the operational aspect of a bicycle component may be the same as the “corrected value” for the operational aspect of the bicycle component. For example, considering dropper seatpost 106, in some instances, the “value for the apparent actuation events” for dropper seatpost 106 may be the same as the “corrected value for the apparent actuations” for dropper seatpost 106.

Additionally, in various embodiments of the present invention, time-based mechanism can be used in combination with the aforementioned determination of the value for the operational aspect of a bicycle component and the “corrected value” for the operational aspect of the bicycle component. For example, in some embodiments, a bicycle component, such as, for example, a suspension component, will utilize two sensors such as a motion sensor (e.g., an accelerometer coupled with the interior and/or exterior of the suspension component) and a current sensor (coupled with, for example, a valve assembly of the motive unit of the suspension component). Such embodiments may also work in conjunction with a clock mechanism to generate activity information for said suspension component.

Activity information is used in various embodiments of the present invention to, for example, preserve battery life, or more accurately determine the period between a suggested service for the suspension component. Various embodiments of the present invention utilize an inactivity timer (e.g., the clock mechanism) in combination with one or more threshold values to determine if the suspension component is actually in an “active state” (being used) or if the suspension unit is actually in an “inactive state” (not being used). An “inactive state”, despite the motion sensor detecting motion of the suspension component or the bicycle, can occur when, for example, the bicycle is being transported (e.g., the bicycle is currently mounted to a bike rack on a moving vehicle), or the when the bicycle is being otherwise physically moved without the bicycle being ridden. In embodiments of the present invention, such “inactive state” conditions are not counted by the clock mechanism as a “period of use” of the suspension component. Conversely, in embodiments of the present invention, “active state” conditions are counted by the clock mechanism as a “period of use” of the suspension component. It should also be noted that in some embodiments of the present invention, the clock mechanism may also measure the duration of time since the last servicing of the suspension component.

In various embodiments of the present invention, processor 110 utilizes one or more algorithms or processing methods to accurately generate the aforementioned a preventative maintenance suggestion corresponding to dropper seatpost 106. In one embodiment, processor 110 employs a counter to determine the value of apparent actuations of dropper seatpost 106. In one such embodiment, processor 110 will compare the value of apparent actuations of dropper seatpost 106 to data in a pre-established lookup table. When certain logical conditions are satisfied, for example a certain value of apparent actuations of dropper seatpost 106, a preventative maintenance suggestion corresponding to dropper seatpost 106 can be offered to the user of dropper seatpost 106. In another embodiment, processor 110 will compare the value of state changes, for example, “duty cycles” (dropper seatpost 106 is moved down, or dropper seatpost 106 is moved down) or simply the number of distinct state changes of some portion of the controller or motive force of dropper seatpost 106 to data in a pre-established lookup table. When certain logical conditions are satisfied, for example a certain value of apparent actuations of dropper seatpost 106, a preventative maintenance suggestion corresponding to dropper seatpost 106 can be offered to the user of dropper seatpost 106.

Additionally, in various other embodiments, processor 110 utilizes one or more artificial intelligence-based (AI-based) processes, one or more machine learning processes, one or more neural networks, and/or one or more similar intelligent process to predict the wear state of dropper seatpost 106, based upon data received by processor 110 from sensors 116, 117 and 119, to generate a preventative maintenance suggestion corresponding to dropper seatpost 106.

Referring still to 204, as stated above, in various embodiments of the present invention, processor 110 evaluates the value of apparent actuations of dropper seatpost 106 and then obtains a corrected value for the apparent actuation events for dropper seatpost 106 by identifying unsuccessful actuations of dropper seatpost 106 which were included in original value of apparent actuation events for dropper seatpost 106. More specifically, during use of dropper seatpost 106, it is possible that sensors 116, 117 and 119, in the aggregate, will identify one or more events as an indication that dropper seatpost 106 has been actuated. However, it is also possible that the one or more events identified by the combination of sensors 116, 117 and 119 did not result in a successful actuation of dropper seatpost 106. For example, sensor 117 might detect depressions of switch 108 and report each of the depressions to processor 110 as a separate dropper seatpost actuation even though each detected depressions of switch 108 did not result in an actuation of dropper seatpost 106. A depression of switch 108, as detected by sensor 117, may not result in a successful actuation of dropper seatpost 106 due to, for example, switch 108 being depressed too quickly (i.e., switch 108 being depressed too many times in too short of a time). It is also possible that a depression of switch 108, as detected by sensor 117, may not result in an actuation due to, for example, switch 108 being depressed just enough to be detected by sensor 117 but not depressed enough to cause a successful actuation of dropper seatpost 106. Also, sensor 119 might detect an actuation signal for dropper seatpost 106, even though the detected actuation signal did not result in a successful actuation of dropper seatpost 106 due to, for example, a communication glitch or communication error. It is further possible that, for example, after a prolonged lack of use of dropper seatpost 106, sensors 117 and 119 might detect a valid depression of switch 108 and a valid actuation signal, respectively, but the motive force for dropper seatpost will fail to cause a successful actuation of dropper seatpost 106.

Hence, The preventative maintenance suggestion provided by embodiments of the present invention is significantly more accurate than, and is significantly improved when compared to, conventional time-based approaches and also over approaches which merely count the detection of events in order to provide a maintenance suggestion. More specifically, the preventative maintenance suggestion provided by various embodiments of the present invention is derived from the actual number of successful actuations of dropper seatpost 106.

Referring again to FIG. 2 and, more specifically, to 206 of flow chart 200, in various embodiments of the present invention, processor 110 includes a preventative maintenance suggestion module 121. Preventative maintenance suggestion module 121 may be implemented in hardware, firmware, software or some combination thereof. Additionally, in various embodiments of the present invention, preventative maintenance suggestion module 121 may be separate from (rather than integrated with) processor 116. In embodiments of the present invention, preventative maintenance suggestion module 121 is configured to generate the preventative maintenance suggestion. In one embodiment, the preventative maintenance suggestion is based, at least partially, upon the corrected value for said operational aspect of bicycle component. In various embodiments, preventative maintenance suggestion module 121 is configured to generate the preventative maintenance suggestion for dropper seatpost 106 based, at least partially, upon the corrected value for the apparent number of actuations of dropper seatpost 106.

With reference now to 208 of flow chart 200 as shown in FIG. 2, preventative maintenance suggestion module 121 is configured to make the preventative maintenance suggestion available to a user of a bicycle component. In various embodiments of the present invention, preventative maintenance suggestion module 121 is configured to make the preventative maintenance suggestion for dropper seatpost 106 available to a user of dropper seatpost 106. In one embodiment, preventative maintenance suggestion module 121 is configured to provide the preventative maintenance suggestion to a user of bicycle 100 and dropper seatpost 106 via, for example, optional user interface 114 of FIG. 1. In another embodiment, preventative maintenance suggestion module 121 is configured to provide the preventative maintenance suggestion to a user of bicycle 100 and dropper seatpost 106 via, for example, a mobile device of the user of bicycle 100 and dropper seatpost 106. Moreover, in various embodiments, preventative maintenance suggestion module 121 provides the preventative maintenance suggestion to a user of dropper seatpost 106 via, for example, other mechanisms including an audio-based mechanism, a visual-based mechanism (e.g., a light emitting diode (LED) display), a tactile-based mechanism or any combination thereof.

The foregoing Detailed Description is not intended to be exhaustive or to limit the embodiments to the precise form described. Instead, example embodiments in this Detailed Description have been presented in order to enable persons of skill in the art to make and use embodiments of the described subject matter. Moreover, various embodiments have been described in various combinations. However, any two or more embodiments can be combined. Although some embodiments have been described in a language specific to structural features and/or methodological acts, it is to be understood that the subject matter defined in the appended Claims is not necessarily limited to the specific features or acts described above. Rather, the specific features and acts described above are disclosed by way of illustration and as example forms of implementing the Claims and their equivalents.

What is claimed is:

1. A system for generating a preventative maintenance suggestion corresponding to a bicycle component, said system comprising:
a plurality of sensors configured to be coupled with said bicycle component, said plurality of sensors configured to determine a value for an operational aspect of said bicycle component;
a processor configured to be communicatively coupled with said plurality of sensors, said processor configured to receive said value for said operational aspect of said bicycle component from said plurality of sensors, said processor further configured to evaluate said value for said operational aspect of said bicycle component and correct said value to obtain a corrected value for said operational aspect of said bicycle component, wherein said operational aspect of said bicycle component is not solely based upon a time-based measurement for a bicycle with which said bicycle component is utilized; and
a preventative maintenance suggestion module coupled with said processor, said preventative maintenance suggestion module configured to generate said preventative maintenance suggestion and make said preventative maintenance suggestion available to a user of said bicycle component, said preventative maintenance suggestion based, at least partially, upon said corrected value for said operational aspect of said bicycle component.

2. The system of claim 1 wherein said bicycle component is a dropper seatpost.

3. The system of claim 1 wherein at least one of said plurality of sensors is integrated within said processor.

4. The system of claim 1 wherein at least one of said plurality of sensors is integrated with a controller.

5. The system of claim 1 wherein at least one of said plurality of sensors is physically separate from a controller.

6. The system of claim 2 wherein at least one of said plurality of sensors is disposed proximate said dropper seatpost.

7. The system of claim 2 wherein at least one of said plurality of sensors is integrated with a motive unit for said dropper seatpost.

8. The system of claim 2 wherein said operational aspect includes apparent actuation events for said dropper seatpost.

9. The system of claim 8 wherein said processor is further configured to obtain a corrected value for said apparent actuation events for said dropper seatpost by identifying unsuccessful actuations of said dropper seatpost included in said apparent actuation events for said dropper seatpost.

10. The system of claim 2 wherein operational aspect includes energy usage by a motive mechanism of said dropper seatpost.

11. The system of claim 1 wherein said processor is integrated with a controller.

12. The system of claim 1 wherein said processor is physically separate from a controller.

13. The system of claim 1 further comprising:
a time-based mechanism, said time-based mechanism generating activity information for said bicycle component, said activity information utilized in combination with said value for said operational aspect of said bicycle component and said corrected value for said operational aspect of said bicycle component to generate said preventative maintenance suggestion.

14. The system of claim 2 wherein said processor is integrated with a motive unit for said dropper seatpost.

15. The system of claim 1 wherein said bicycle component is a suspension component.

16. The system of claim 1 wherein said preventative maintenance suggestion module is configured to provide said preventative maintenance suggestion to said user of said bicycle component via a mobile device of said user of said bicycle component.

17. A non-transitory computer-readable storage medium including instructions that, when executed by a processor, cause said processor to perform steps for generating a preventative maintenance suggestion corresponding to a dropper seatpost, said steps comprising:
utilizing a plurality of sensors to determine a value for apparent actuation events for said dropper seatpost;
receiving said value for said apparent actuation events for said dropper seatpost at said processor, said process configured to evaluate said value for said apparent actuation events for said dropper seatpost and correct said value for said apparent actuation events for said dropper seatpost to obtain a corrected value for said apparent actuation events for said dropper seatpost; and
using a preventative maintenance suggestion module to generate said preventative maintenance suggestion corresponding to said dropper seatpost, said preventative maintenance suggestion at least partially based upon said corrected value for said apparent actuation events for said dropper seatpost.

18. The non-transitory computer-readable storage medium of claim 17, wherein said processor further performs the step of:
obtaining said corrected value for said apparent actuation events for said dropper seatpost by identifying unsuccessful actuations of said dropper seatpost included in said apparent actuation events for said dropper seatpost.

19. A method for generating a preventative maintenance suggestion corresponding to a dropper seatpost, said method comprising:
utilizing a plurality of sensors to determine a value for apparent actuation events for said dropper seatpost;
receiving said value for said apparent actuation events for said dropper seatpost at said processor, said process configured to evaluate said value for said apparent actuation events for said dropper seatpost and correct said value for said apparent actuation events for said dropper seatpost to obtain a corrected value for said apparent actuation events for said dropper seatpost;
using a preventative maintenance suggestion module to generate said preventative maintenance suggestion corresponding to said dropper seatpost, said preventative maintenance suggestion at least partially based upon said corrected value for said apparent actuation events for said dropper seatpost; and
making said preventative maintenance suggestion available to a user of said dropper seatpost.

20. The method of claim 19, further comprising:
obtaining said corrected value for said apparent actuation events for said dropper seatpost by identifying unsuccessful actuations of said dropper seatpost included in said apparent actuation events for said dropper seatpost.
